(19) United States
(12) Patent Application Publication
(10) Pub. No.: US 2026/0024288 A1
(43) Pub. Date: Jan. 22, 2026

(54) HIGH-QUALITY MIXED REALITY HEADSET AND CONTROLLER TRACKING IN MOVING VEHICLES

(71) Applicant: Meta Platforms Technologies, LLC, Menlo Park, CA (US)

(72) Inventors: Luc Oth, Zurich (CH); Anastasios Mourikis, Seattle, WA (US); Kevin Eckenhoff, Kirkland, WA (US); David Caruso, Redmond, WA (US)

(21) Appl. No.: 19/272,416

(22) Filed: Jul. 17, 2025

(30) Foreign Application Priority Data
Jul. 17, 2024 (GR) 20240100501

(51) Int. Cl. G06T 19/00; G02B 27/01; G06F 3/01; G06V 20/52

(52) U.S. Cl. CPC G06T 19/006; G02B 27/017; G06F 3/012; G06V 20/52

(57) ABSTRACT

Various aspects of the subject technology relate to systems, methods, and machine-readable media for rendering media in a mixed reality device moving in a non-inertial reference frame. Various aspects include identifying tracking points associated with a moving platform defined by a non-inertial reference frame; receiving a first and a second set of monitoring data from a mixed reality headset comprising: a camera device, a headset IMU, and a controller IMU; receiving a second set of tracking data from the mixed reality headset; predicting by a prediction model a movement of the tracking points; determining a discrepancy between the predicted movement of at least one of the tracking points and the second set of tracking data, wherein the discrepancy exceeds an error threshold; and in response to determining the discrepancy, generating display data for rendering a display image in the mixed reality headset.

### CROSS REFERENCE TO RELATED APPLICATIONS

The present application claims the benefit of priority under 35 U.S.C. § 111 to Greek Patent Application No. 20240100501, filed on Jul. 17, 2024, the entire contents of which are incorporated herein by reference in their entirety.

### TECHNICAL FIELD

The present disclosure generally relates to display technologies, and more particularly, to mixed reality device monitoring in moving vehicles.

### BACKGROUND

The existing headset tracking devices offer on-the-ground high quality tracking. The current technology implements a six-degree-of-freedom (6DoF) tracking to render images for a headset. The methods to render images for headsets require a fusion of inertial information from an inertial measurement unit (IMU) and visual information gained from cameras associated with the headset. Using the fusion method typically works outside of a vehicle because the camera observes features that are not moving with respect to an inertial reference frame. However, difficulties in rendering media for the headset occur when the headset is in a moving platform.

### BRIEF SUMMARY

The subject disclosure provides methods and systems for rendering media in a mixed reality device while the mixed reality device is in a moving vehicle. According to one embodiment of the present disclosure, a computer-implemented method for rendering media in a mixed reality headset operating in a moving platform is provided. The method includes identifying a plurality of platform tracking points associated with a moving platform defined by a non-inertial reference frame. The method includes receiving a first set of monitoring data from a mixed reality headset. The data set includes at least one camera device configured to capture the plurality of tracking points and a headset inertial measurement unit (IMU). In one aspect, the data set can also include data from at least one controller associated with the mixed reality headset comprising a controller inertial measurement unit (IMU). The method also includes receiving a second set of tracking data from the mixed reality headset. The method includes predicting by a prediction model a movement of the plurality of tracking points based on the first set with respect to the non-inertial reference frame. The method further includes determining a discrepancy between the predicted movement of at least one of the plurality of tracking points and the second set of tracking data, wherein the discrepancy exceeds an error threshold. The method includes in response to determining the discrepancy, generating display data for rendering a display image in the mixed reality headset.

According to one embodiment of the present disclosure, a system is provided including a processor and a memory comprising instructions stored thereon, which when executed by the processor, causes the processor to perform a method for rendering media in a mixed reality headset operating in a moving platform. The instructions include identifying a plurality of platform tracking points associated with a moving platform defined by a non-inertial reference frame. The instructions include receiving a first set of monitoring data from a mixed reality headset. The data set includes at least one camera device configured to capture the plurality of tracking points and a headset inertial measurement unit (IMU). In one aspect, the data set can also include data from at least one controller associated with the mixed reality headset comprising a controller inertial measurement unit (IMU). The instructions include receiving a second set of tracking data from the mixed reality headset. The instructions include predicting by a prediction model a movement of the plurality of tracking points based on the first set with respect to the non-inertial reference frame. The instructions include determining a discrepancy between the predicted movement of at least one of the plurality of tracking points and the second set of tracking data, wherein the discrepancy exceeds an error threshold. The instructions include in response to determining the discrepancy, generating display data for rendering a display image in the mixed reality headset.

According to one embodiment of the present disclosure, a non-transitory computer-readable storage medium is provided including instructions (e.g., stored sequences of instructions) that, when executed by a processor, cause the processor to perform a method for rendering media in a mixed reality headset operating in a moving platform. The method includes identifying a plurality of platform tracking points associated with a moving platform defined by a non-inertial reference frame. The method includes identifying the plurality of tracking points. The method includes receiving a first set of monitoring data from a mixed reality headset. The data set includes at least one camera device configured to capture the plurality of tracking points and a headset inertial measurement unit (IMU). In one aspect, the data set can also include data from at least one controller associated with the mixed reality headset comprising a controller inertial measurement unit (IMU). The method also includes receiving a second set of tracking data from the mixed reality headset. The method includes predicting by a prediction model a movement of the plurality of tracking points based on the first set with respect to the non-inertial reference frame. The method further includes determining a discrepancy between the predicted movement of at least one of the plurality of tracking points and the second set of tracking data, wherein the discrepancy exceeds an error threshold. The method includes in response to determining the discrepancy, generating display data for rendering a display image in the mixed reality headset.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram illustrating an overview of devices on which some implementations of the disclosed technology can operate.

FIG. 2A is a wire diagram of a mixed reality head-mounted display (HMD), in accordance with one or more implementations.

FIG. 2B is a wire diagram of a mixed reality HMD system which includes a mixed reality HMD and a core processing component, in accordance with one or more implementations.

FIGS. 3A-3B are a depiction of a controller in communication with a mixed reality.

FIG. 4 is a block diagram illustrating an overview of an environment, in which some implementations of the disclosed technology can operate.

FIG. 5 is a depiction of a mixed reality headset in a moving platform traversing an inertial and non-inertial frame of reference.

FIG. 6 is a depiction of a mixed reality headset rendering a user interface while the user is seated in an interior of a moving platform comprising a car.

FIG. 7 is a depiction of a mixed reality headset rendering a user interface while the user is seated in a moving platform comprising a boat.

FIG. 8 is a block diagram illustrating an example computer system (e.g., representing both client and server) with which aspects of the subject technology can be implemented.

FIG. 9 is an example flow diagram for rendering a display in a mixed reality device while in a moving platform, according to certain aspects of the present disclosure.

FIG. 10 is a block diagram illustrating an example computer system with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

In one aspect, unless otherwise stated, all measurements, values, ratings, positions, magnitudes, sizes, and other specifications that are set forth in this specification, including in the clauses that follow, are approximate, not exact. In one aspect, they are intended to have a reasonable range (e.g., +/−10%) that is consistent with the functions to which they relate and with what is customary in the art to which they pertain. It is understood that some or all steps, operations, or processes may be performed automatically, without the intervention of a user. Method clauses may be provided to present elements of the various steps, operations, or processes in a sample order, and are not meant to be limited to the specific order or hierarchy presented.

Embodiments of the disclosed technology may include or be implemented in conjunction with a mixed reality system. The term “mixed reality” or “MR” as used herein refers to a form of reality that has been adjusted in some manner before presentation to a user, which may include, e.g., virtual reality (VR), augmented reality (AR), extended reality (XR), hybrid reality, or some combination and/or derivatives thereof. Mixed reality content may include completely generated content or generated content combined with captured content (e.g., real-world photographs). The mixed reality content may include video, audio, haptic feedback, or some combination thereof, any of which may be presented in a single channel or in multiple channels (such as stereo video that produces a three-dimensional (3D) effect to the viewer). Additionally, in some embodiments, mixed reality may be associated with applications, products, accessories, services, or some combination thereof, that are, e.g., used to interact with content in an immersive application. The mixed reality system that provides the mixed reality content may be implemented on various platforms, including a head-mounted display (HMD) connected to a server, a host computer system, a standalone HMD, a mobile device or computing system, a “cave” environment or other projection system, or any other hardware platform capable of providing mixed reality content to one or more viewers. Mixed reality may be equivalently referred to herein as “artificial reality.”

“Virtual reality” or “VR,” as used herein, refers to an immersive experience where a user's visual input is controlled by a computing system. “Augmented reality” or “AR” as used herein refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. AR also refers to systems where light entering a user's eye is partially generated by a computing system and partially composes light reflected off objects in the real world. For example, an AR headset could be shaped as a pair of glasses with a pass-through display, which allows light from the real world to pass through a waveguide that simultaneously emits light from a projector in the AR headset, allowing the AR headset to present virtual objects intermixed with the real objects the user can see. The AR headset may be a block-light headset with video pass-through. “Mixed reality” or “MR,” as used herein, refers to any of VR, AR, XR, or any combination or hybrid thereof.

In certain aspects, safety and privacy protocols are implemented so that the user understands user eye data is obtained by the system. The user is informed in advance of the purpose for obtaining the eye data, and may at any time opt out of the eye data being obtained. In certain aspects, the user may delete any past eye data stored by the system. Users who proceed with using the system may be notified that respective eye-movement data is being obtained for the purpose of determining pupil location as a representation of focusing direction of the user's eyes to more efficiently generate a foveated view in that respective direction.

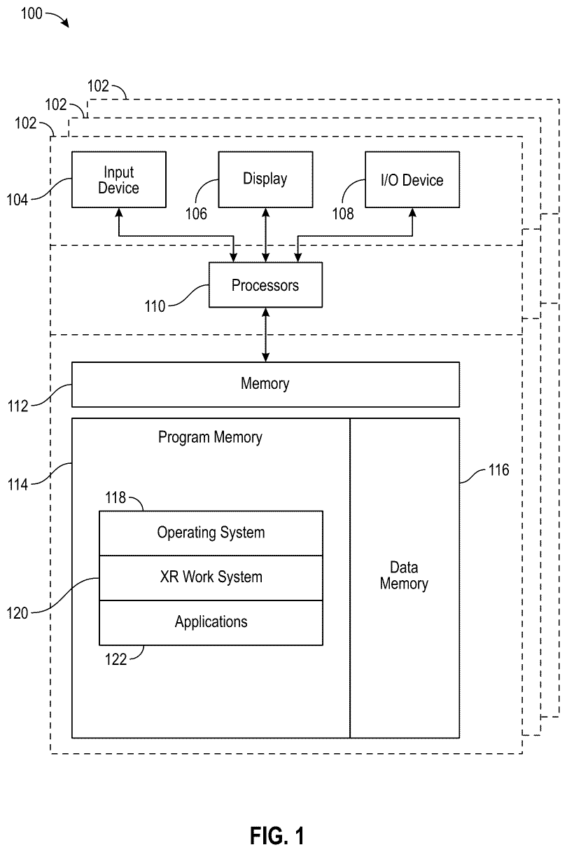

Several implementations are discussed below in more detail in reference to the figures. FIG. 1 is a block diagram of a device operating environment 100 with which aspects of the subject technology can be implemented. The device operating environment can comprise hardware components of a computing system 100 that can create, administer, and provide interaction modes for a shared artificial reality environment (e.g., gaming artificial reality environment) such as for individual control of audio (e.g., switching audio sources) via XR elements and/or real-world audio elements. The interaction modes can include different audio sources or channels for each user of the computing system 100. Some of these audio channels may be spatialized or non-spatialized. In various implementations, the computing system 100 can include a single computing device or multiple computing devices 102 that communicate over wired or wireless channels to distribute processing and share input data.

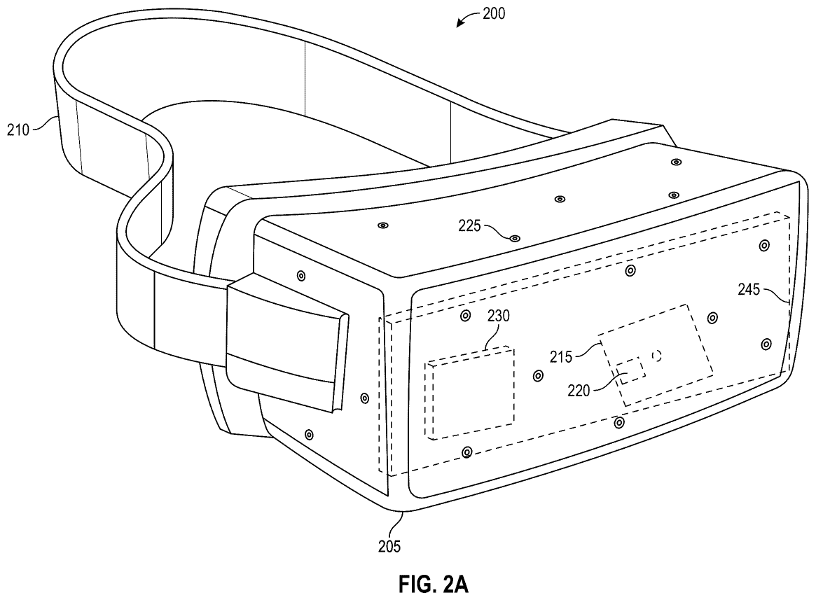

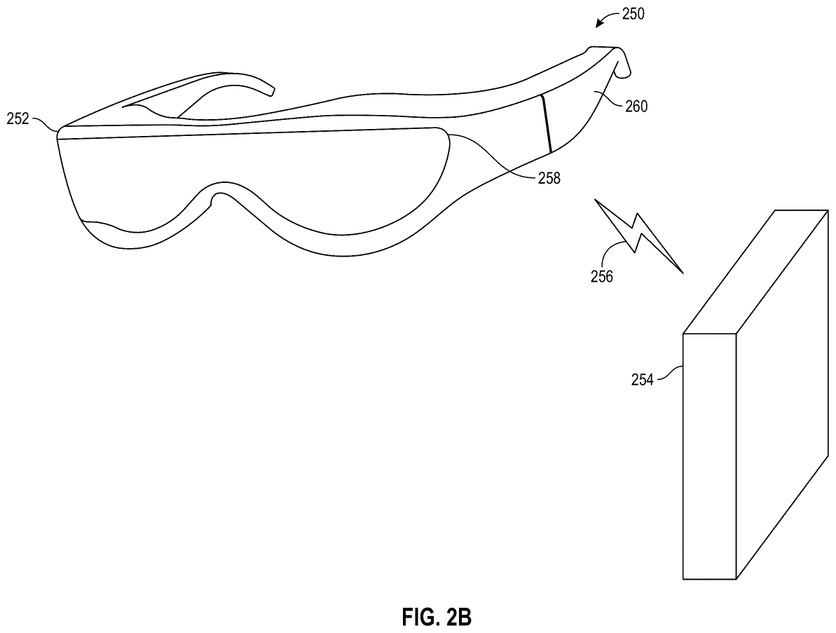

In some implementations, the computing system 100 can include a stand-alone headset capable of providing a computer created or augmented experience for a user without the need for external processing or sensors. In other implementations, the computing system 100 can include multiple computing devices 102 such as a headset and a core processing component (such as a console, mobile device, or server system) where some processing operations are performed on the headset and others are offloaded to the core processing component. Example headsets are described below in relation to FIGS. 2A-2B. In some implementations, position and environment data can be gathered only by sensors incorporated in the headset device, while in other implementations one or more of the non-headset computing devices 102 can include sensor components that can track environment or position data, such as for implementing computer vision functionality. Additionally or alternatively, such sensors can be incorporated as wrist sensors, which can function as a wrist wearable for detecting or determining user input gestures. For example, the sensors may include inertial measurement units (IMUs), eye tracking sensors, electromyography (e.g., for translating neuromuscular signals to specific gestures), time of flight sensors, light/optical sensors, and/or the like to determine the input gestures, how user hands/wrists are moving, and/or environment and position data.

The computing system 100 can include one or more processor(s) 110 (e.g., central processing units (CPUs), graphical processing units (GPUs), holographic processing units (HPUs), inertial measurement units (IMUs)). The processors 110 can be a single processing unit or multiple processing units in a device or distributed across multiple devices (e.g., distributed across two or more of computing devices 102). The computing system 100 can include one or more input devices 104 that provide input to the processors 110, notifying them of actions. The actions can be mediated by a hardware controller that interprets the signals received from the input device 104 and communicates the information to the processors 110 using a communication protocol. As an example, the hardware controller can translate signals from the input device 104 to render audio, motion, or other signal-controlled features in the shared XR environment. Each input device 104 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, and/or other user input devices.

The processors 110 can be coupled to other hardware devices, for example, with the use of an internal or external bus, such as a PCI bus, SCSI bus, wireless connection, and/or the like. The processors 110 can communicate with a hardware controller for devices, such as for a display 106. The display 106 can be used to display text and graphics. In some implementations, the display 106 includes the input device as part of the display, such as when the input device is a touchscreen or is equipped with an eye direction monitoring system. In some implementations, the display is separate from the input device. Examples of display devices include an LCD display screen, an LED display screen, a projected, holographic, or augmented reality display (such as a heads-up display device or a head-mounted device), and/or the like. Other I/O devices 108 can also be coupled to the processor, such as a network chip or card, video chip or card, audio chip or card, USB, firewire or other external device, camera, printer, speakers, CD-ROM drive, DVD drive, disk drive, etc.

The computing system 100 can include a communication device capable of communicating wirelessly or wire-based with other local computing devices 102 or a network node. The communication device can communicate with another device or a server through a network using, for example, TCP/IP protocols. The computing system 100 can utilize the communication device to distribute operations across multiple network devices. For example, the communication device can function as a communication module. The communication device can be configured to transmit or receive audio signals.

The processors 110 can have access to a memory 112, which can be contained on one of the computing devices 102 of the computing system 100 or can be distributed across one of the multiple computing devices 102 of the computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. The memory 112 can include program memory 114 that stores programs and software, such as an operating system 118, XR work system 120, and other application programs 122 (e.g., XR games). The memory 112 can also include data memory 116 that can include information to be provided to the program memory 114 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, and/or the like.

FIGS. 2A-2B are diagrams illustrating virtual reality headsets, according to certain aspects of the present disclosure. FIG. 2A is a diagram of a virtual reality head-mounted display (HMD) 200. The HMD 200 includes a front rigid body 205 and a band 210. The front rigid body 205 includes one or more electronic display elements such as an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in a virtual environment in three degrees of freedom (3DoF), six degrees of freedom (6DoF), etc. For example, the locators 225 can emit infrared light beams which create light points on real objects around the HMD 200. As another example, the IMU 215 can include, e.g., one or more accelerometers, gyroscopes, magnetometers, other non-camera-based position, force, or orientation sensors, or combinations thereof. One or more cameras (not shown) integrated with the HMD 200 can detect the light points, such as for a computer vision algorithm or module. The compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof. The electronic display 245 can be coupled with an audio component, such as to send and receive output from various other users of the XR environment wearing their own XR headsets, for example. The audio component can be configured to host multiple audio channels, sources, or modes.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a diagram of a mixed reality HMD system 250 which includes a mixed reality HMD 252 and a core processing component 254. The mixed reality HMD 252 and the core processing component 254 can communicate via a wireless connection (e.g., a 60 GHZ link) as indicated by the link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown), such as light projectors (e.g., LASERs, LEDs, etc.), cameras, eye-tracking sensors, MEMS components, networking components, etc. The frame 260 or another part of the mixed reality HMD 252 may include an audio electronic component such as a speaker. The speaker can output audio from various audio sources, such as a phone call, VOIP session, or other audio channel. The electronic components may be configured to implement audio switching based on user gaming or XR interactions.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects. For example, the HMD system 250 can track the motion and position of the user's wrist movements as input gestures for performing XR navigation. As an example, the HMD system 250 may include a coordinate system to track the relative positions of various XR objects and elements in a shared artificial reality environment.

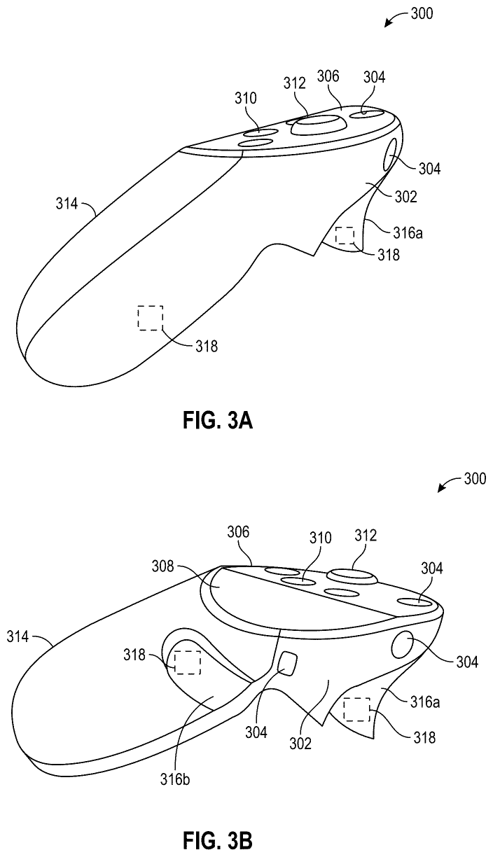

FIGS. 3A and 3B illustrate different views of an example self-tracking controller 300, in accordance with one or more implementations. The controller 300 may be configured for interacting with a mixed reality environment. The controller 300 may be configured to communicatively pair with a head-mounted display (e.g., the HMD 200 of FIG. 2A and/or the HMD system 250 of FIG. 2B) for mixed reality environments. The controller 300 may be one of a pair of controllers configured to be used contemporaneously (e.g., one in each hand of a user).

The controller 300 may include a housing 302. The housing 302 may include at least one sensor 304. The controller may also include controller position sensors, a controller IMU 215 internal to the controller housing 302 and may not be visible to the user. The sensor(s) 304 may be configured to collect information used to determine a position and/or motion of the controller. The information may include optical information (e.g., visible, infrared, etc.), spatial information (e.g., LIDAR output), movement information (e.g., MEMS output), biometric information (e.g., whether user is holding controller 300) and/or other types of information. The sensor(s) 304 may be located on at least one side of the housing 302. The sensor(s) 304 may include at least one camera. In some embodiments, the controller 300 may include a first sensor 304 and a second sensor 304 located on different sides of the housing 302. A field of view of the first sensor 304 may overlap with a field of view of the second sensor 304.

The sensor(s) 304 may be configured for self-tracking movements by the controller 300. In other words, the sensor(s) 304 may be configured to facilitate determinations of the position and/or motion of the controller 300 without external sensors. Because external sensors are not needed, the controller 300 may have an unlimited tracking volume (or at least one not defined by the placement of external sensors).

The controller 300 may include a thumb plate 306 coupled to the housing 302. The thumb plate 306 may include a touchpad 308, one or more actuators 310, a joystick 312, and/or other components. The touchpad 308 may be configured to contact a user's thumb. The user may provide inputs to the touchpad 308 with their thumb by touching different locations on the touchpad 308, moving their thumb across the touchpad 308, applying pressure to the touchpad 308, and/or other thumb gestures. The actuator(s) 310 may include buttons and/or other binary input devices. The joystick 312 may be configured to move linearly (e.g., up, down, left, right, diagonal, etc.), circularly (e.g., clockwise, counterclockwise, etc.), and/or in other motions. In some implementations, the joystick 312 may be configured to be depressed (e.g., a binary button push).

The housing 302 of the controller 300 may include a handle 314. The controller 300 may be configured for either a right hand (e.g., the controller 300 as shown in FIG. 3A) or a left hand (e.g., the controller 300 shown in FIG. 3B). The handle 314 may be configured to be held by the user by grasping with three or more fingers around the handle 314. The handle 314 may include one or more actuators 310 and/or one or more triggers 316. When the user is holding the controller 300, the user's index finger may align with trigger 316a and/or the user's thumb may align with trigger 316b. The thumb plate 306 may be positioned such that, when the user is holding the handle 314 of the controller 300 with one hand, the user's thumb can rest on the thumb plate 306 and/or apply orthogonal force to the thumb plate 306. The controller 300 may be configured to activate a precision pinch feature based on inputs received from the touchpad 308 and/or at least one trigger 316. For example, the precision pinch feature may be based at least in part on simultaneous inputs received from the touchpad and at least one trigger.

The controller 300 may include one or more haptics actuators 318. The haptics actuator(s) 318 may be configured to provide haptic feedback to a user holding the controller 300. The haptics actuator(s) 318 may be configured to provide haptic feedback to a user performing a fine motor activity. The haptic feedback may provide an experience of touch through application of one or more of vibrations, force, motions, and/or other haptic feedback. Examples of haptics actuator(s) 318 may include one or more of an eccentric rotating mass (ERM) actuator, a linear resonant actuator (LRA), piezoelectric actuators, servomotors, and/or other haptics actuators. In some implementations, haptic feedback is localized at one or more different positions on the controller 300. For example, in some implementations, the controller 300 comprises a first haptics actuator 318 disposed at a trigger 316. The controller 300 may include a second haptics actuator 318 disposed at the thumb plate 306. Thus, haptic feedback can be applied selectively to the user's index finger, the user's thumb, the user's palm, and/or other locations.

The trigger 316 can be oriented on a side surface of the housing 302. The housing can define an interior cavity such that squeezing the trigger can cause a portion of the trigger 316 to enter the cavity 330. The trigger 316 can comprise a material with sufficient thickness to transfer the force from the fingers to the internal components of the controller 300. The trigger(s) 316 may have variable resistance when pulled by the user. That is, the resistance felt by the user when they squeeze a trigger 316 may be different at different times. The variable resistance may be determined in response to and/or based on a fine motor activity performed by a user. For example, the trigger resistance may increase when an index finger and/or thumb of a virtual hand being controlled by controller 300 comes into contact with a virtual object (e.g., when picking up the virtual object). Such an increase in resistance may give the user a sensation of “touching” the virtual object. According to some implementations, the trigger(s) 316 may be configured with a long throw (e.g., more than one centimeter of travel) or a short throw (e.g., less than one centimeter of travel).

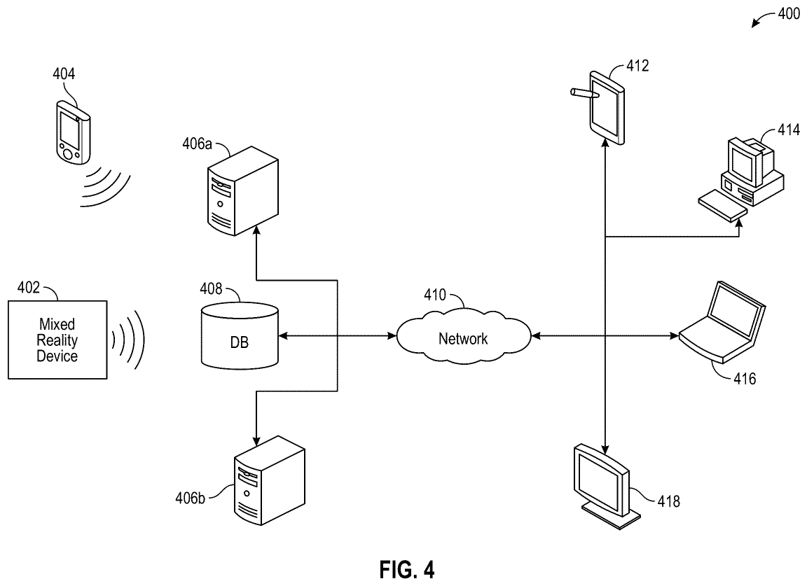

FIG. 4 is a block diagram illustrating an overview of an environment 400 in which some implementations of the disclosed technology can operate. The environment 400 can include one or more client computing devices, such as mixed reality device 402, mobile device 404, tablet 412, personal computer 414, laptop 416, desktop 418, and/or the like. The mixed reality device 402 may be the HMD 200, HMD system 250, a wrist wearable, or some other MR device that is compatible with rendering or interacting with a mixed reality environment. The mixed reality device 402 and mobile device 404 may communicate wirelessly via the network 410. In some implementations, some of the client computing devices can be the HMD 200 or the HMD system 250. The client computing devices can operate in a networked environment using logical connections through network 410 to one or more remote computers, such as a server computing device.

In some implementations, the environment 400 may include a server such as an edge server which receives client requests and coordinates fulfillment of those requests through other servers. The server may include server computing devices 406a-406b, which may logically form a single server. Alternatively, the server computing devices 406a-406b may each be a distributed computing environment encompassing multiple computing devices located at the same or at geographically disparate physical locations. The client computing devices and server computing devices 406a-406b can each act as a server or client to other server/client device(s).

The server computing devices 406a-406b can connect to a database 408 or can comprise its own memory. Each server computing devices 406a-406b can correspond to a group of servers, and each of these servers can share a database or can have their own database. The database 408 may logically form a single unit or may be part of a distributed computing environment encompassing multiple computing devices that are located within their corresponding server, located at the same or at geographically disparate physical locations.

The network 410 can be a local area network (LAN), a wide area network (WAN), a mesh network, a hybrid network, or other wired or wireless networks. The network 410 may be the Internet or some other public or private network. Client computing devices can be connected to network 410 through a network interface, such as by wired or wireless communication. The connections can be any kind of local, wide area, wired, or wireless network, including the network 410 or a separate public or private network. In some implementations, the server computing devices 406a-406b can be used as part of a social network such as implemented via the network 410. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc.

The disclosed technology relates to a high-quality mixed reality headset tracking in moving vehicles. A device of the subject technology enables headset tracking in a moving frame by relying on estimation of properties of the moving frame's motion and modeling on the observed sensor data. Examples of the moving frame's motion parameters include: position, orientation, linear and rotational velocity, linear and rotational acceleration, or their derivatives. The disclosed solution in other embodiments can also include a relative controller tracking formulation, which enables tracking controllers in non-inertial frames relative to the headset.

The technical problem addressed by the current disclosure is that the above-mentioned technologies do not support 6DoF headset tracking while on moving vehicles. For example, in headsets, tracking for mixed reality relies on fusion of inertial information received from an inertial measurement unit (IMU) and visual information obtained, for instance, from cameras. These methods typically work only outside of vehicles because they assume that the camera observes features that are not moving with respect to the inertial frame of reference. The disclosed technology provides a method to provide the same mixed reality experience on moving platforms (e.g., planes, trains, cars, buses, etc.).

The subject technology addresses the technical problem through various aspects. The mixed reality devices of the subject technology can work independent of being in a steady non-moving situation or in a moving vehicle. This feature becomes especially relevant as the transition towards all-day wearable mixed devices become more routine. In addition to the mixed reality headset, the subject solution relies on the headset itself for tracking, which allows usage of controllers in moving vehicles as the controllers would normally be used on the ground with no motion.

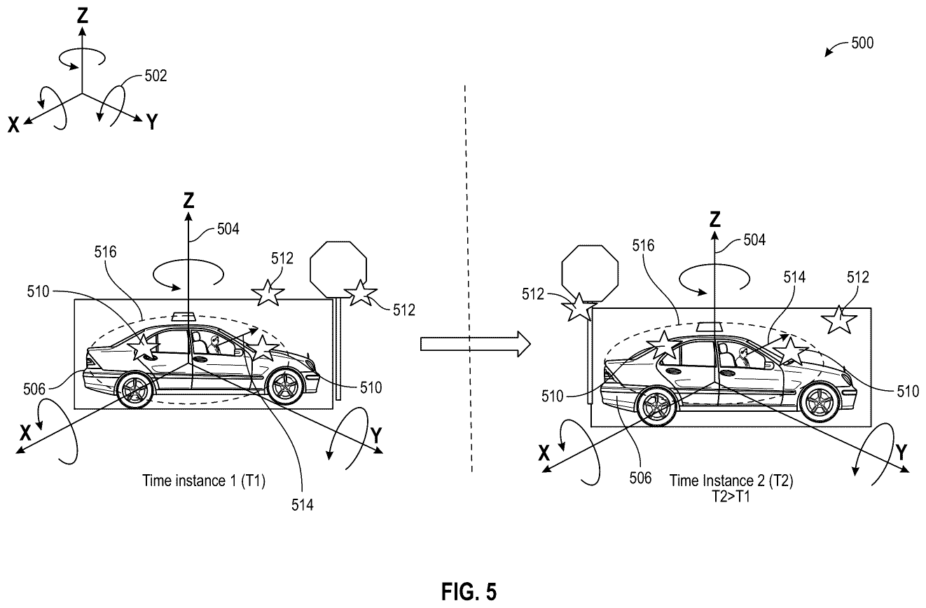

Implementing a continuous rendering of image and audio data for display in a mixed reality device while moving can utilize sensor data received from the IMU of a user's headset device and controllers along with image/audio data from the camera. IMUs measure acceleration (relative to free-fall) and angular velocity with respect to an inertial reference frame (no acceleration or rotation). Integrating these measurements over a period of time gives a constraint between the pose/velocity of the IMU at the beginning of the interval and those at the end, as expressed in an inertial reference frame. In a spatial environment 500 of FIG. 5, an inertial reference frame 502 can be established with a respective coordinate system that can provide coordinates to an object interacting in the inertial reference frame. Further physical constraints can define the DoF for the object in the spatial environment 500. In the inertial reference frame, estimations/predictions can determine an IMU pose and/or velocity. However, when the IMUs and cameras are in a moving platform (car, bus, boat, etc.), the estimations/predictions can lead to discrepancies because the image data received from the cameras will disagree with the predicted pose and/or velocity predicted by the IMU.

To address impact of a moving platform, the current disclosure can utilize a non-inertial reference frame 504 that is fixed to the moving platform 506. Further, the prediction model can be implemented by including motion parameters associated with the moving platform (e.g. car). In a further aspect, the motion parameters can comprise acceleration and angular velocity of the moving platform. In addition, the prediction model also includes a reconciliation with the image data received from the cameras coupled to the mixed reality headset. The parameters provided to the prediction model from the camera are derived from tracking points. The tracking points can comprise regions of a captured image that comprise a visual texture that can be identified by the camera at differing time instances. For example, the visual texture can comprise a pattern of pixels that can be differentiated from an adjacent region in the image captured by the camera. The identified tracking point can be identified from the captured image data at two different time instances to provide an estimation on how the moving platform 506 has actually moved.

In a further aspect, the reconciliation performed by the prediction model can be improved as the model filters the data to tracking points in proximity to the interior of the moving platform (car) 506. In an aspect, the mixed reality headset can be configured to determine a subset of tracking points comprising interior tracking points 510. The interior tracking points 510 are estimated to be bound by the chassis of the moving platform 506. The interior tracking points 510 can also be referenced as moving platform tracking points. Further, the interior tracking points 510 can be differentiated from other tracking points, namely exterior tracking points 512, by defining a threshold distance 514. The exterior tracking points 512 can also be referenced as supplemental tracking points. The threshold distance 514 can define a boundary 516 that is approximate to the chassis of the car. When implementing the prediction model, the exterior tracking points 512 can be filtered from the interior tracking points 510; and the data parameters from the interior tracking points 510 can be used to predict the movement of the headset. The fidelity of the headset's predicted movement can be increased by using the interior tracking point 510 approximately constrained to the chassis of the car 506; the exterior tracking points 512 that are farther away from the mixed reality headset increase the probability of a discrepancy between the predicted movement and actual movement captured by a camera. In an alternate embodiment, the prediction model can use augmented input parameters comprising supplemental tracking points that include the exterior tracking points 512 yielding display data for rendering images both internal and external to the moving platform.

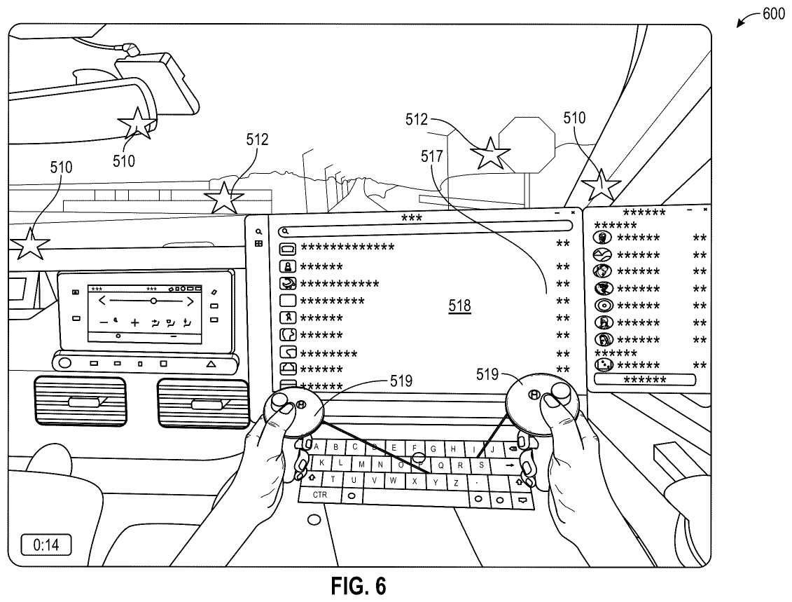

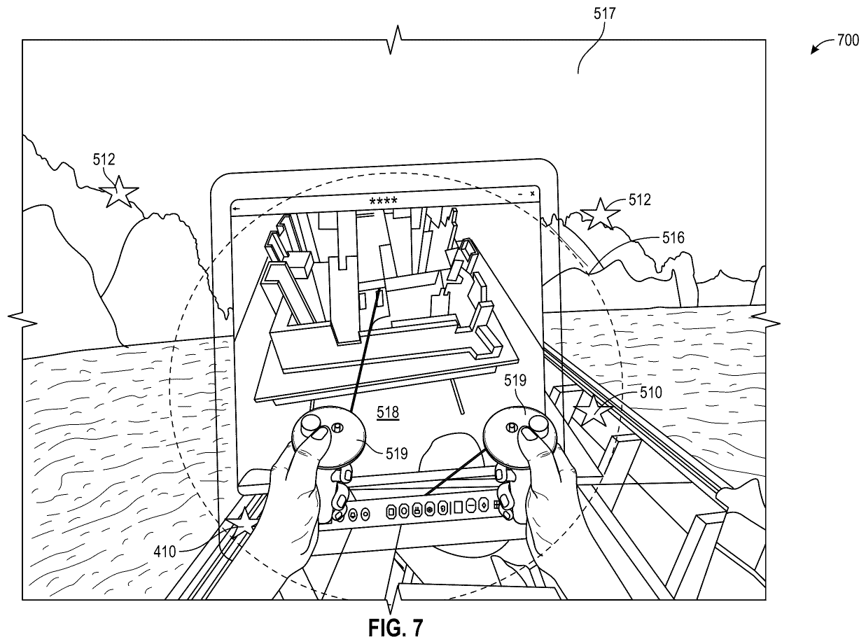

For example, as depicted in FIG. 6, the interior car point of view (POV) 600 from the headset as the user is forward facing is rendered to display both a consistent view of what the user would see as they look out the front windshield and a rendered image 517 comprising a user interface 518. Similarly, the boat POV 700 in FIG. 7 can be rendered with less physical constraints since the boat lacks an overhead chassis; however, the boundary 516 defined by the interior tracking points can still define a constraint for the boat when providing an input to the prediction model. The user interface 518 rendered for display in the mixed reality headset is the result of the prediction model. The respective views being consistent is based on the prediction model effectively predicting the movement of the IMUs and avoiding divergent and/or flickering images. Further, the rendered image 517 can also include the user interface 518 and rendered controller images 519 that interact with the user interface.

As discussed earlier, the prediction model can use the sensor data from the headset IMU to reconcile image data. In further aspects, the prediction model can also include sensor data from a controller. The prediction model predicts a location of the headset and controller based on the data received from the headset IMU and controller IMU at an initial time stamp. The predicted location, pose, and/or velocity associated with the IMUs are subsequently reconciled with the image data captured from the camera(s) at a second instance in time. In an aspect of reconciliation, the data generated for rendering in the display can be updated to be consistent with the image data captured by the camera. The prediction model can also include error analysis and mitigation. The prediction model can be tuned by receiving input parameters to account for the signal noise parameters. For example, the prediction model can identify signal noise parameters associated with the motion of the moving platform (vehicle). In another aspect, the signal noise parameters can be derived from motion sensors associated with the headset device, and/or motion sensors associated with a controller.

In a further aspect, the prediction model can be tuned such that the variance in errors determined during reconciliation can be diminished. The tuning feature can evaluate the rate of discrepancies that are determined for a certain period of time. In further evaluation of tuning parameters, the discrepancies can be classified based on an error threshold. For example, if the difference between the predicted location and the actual location exceeds an error threshold, the respective tracking point can be removed from being used in rendering image data for display. Discrepancies can also be evaluated based on the rate of discrepancies. For example, a discrepancy rate threshold can be evaluated to determine the amount of discrepancies occurring during a defined period of time or the amount of discrepancies occurring during a defined number of reconciliations. In response to the discrepancies exceeding a discrepancy rate threshold, the prediction model can further implement additional parameters to tune the model and reduce the amount of discrepancies.

Another aspect of the tuning feature can comprise an adaptation to the predictive model. In particular, the adaption to the tuning feature can comprise alternating between a smooth or robust prediction model. The smooth version of the prediction model may be used for instances wherein either exceeding the error threshold is low or the discrepancy rate is low, such as instances when the moving platform is experiencing a low rate of fluctuations in amplitude, velocity and acceleration. For example, a smooth model can be implemented when the display data for rendering does not require excessive updating to mitigate a jittery rendered image because the prediction model is in a confident range in comparison with the camera data received from the headset. In contrast, the robust model may be used for instances when either exceeding the error threshold is high or the discrepancy rate is high, requiring an adjustment to the confidence range associated with the prediction models, such as instances when the moving platform is experiencing a high rate of fluctuations in amplitude, velocity and acceleration (e.g., traversing a heavily damaged road).

In another embodiment, the disclosure can monitor the positioning of the headset and render data for display in the headset. The coordinate system associated with the inertial reference frame 502 or the coordinate system associated with the non-inertial reference frame 504 can be used to anchor the model input parameters received from the headset IMU and controller IMU and provide to the prediction model. Being able to anchor the prediction model input parameters can create a system with the advantage of not relying on a third party to coordinate the system. Further, tracking points can be identified in both the inertial reference frame 502 and the non-inertial reference frame. The prediction model input parameters and camera data derived from the interior tracking points 510 and exterior tracking points 512 can be used to generate display data used to render images interior to the moving platform and exterior to the moving platform.

In a further aspect, the headset can also be configured to capture image data from the plurality of cameras at different instances. In an aspect, one image capture configuration may instruct all of the cameras to capture an image at the same time, resulting in multiple views with the same timestamp. Such a configuration can allow the prediction model to have greater fidelity in the position, pose and/or velocity of the headset device for that particular time stamp. For example, a headset device with four cameras can have four views of captured images with the captured images having the same timestamp. In another aspect, another image capture configuration may instruct different cameras to capture image data at different time stamps. Such a configuration differs from the previous configuration in that the prediction model can receive more views at each time stamp. Cameras 1 and 3 can have the same time stamp, while cameras 2 and 4 can have the same time stamp; all four cameras can have different time stamps; and other various camera/timestamp combinations are also possible.

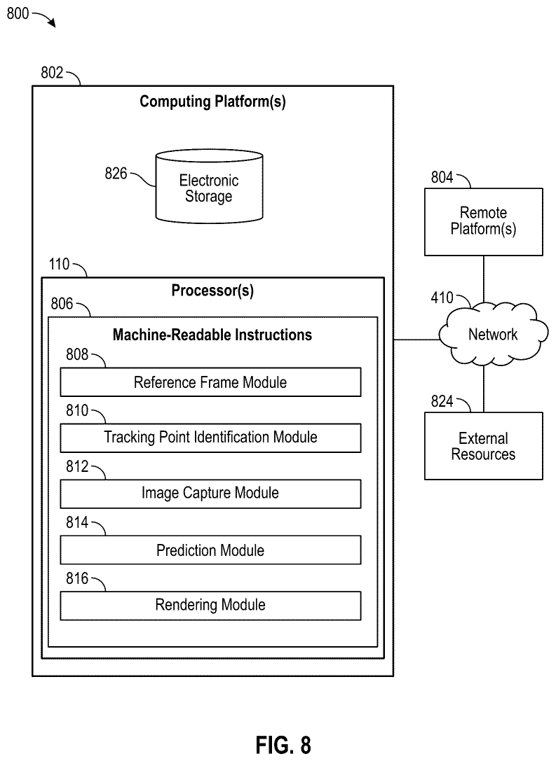

FIG. 8 is a block diagram illustrating an example computer system 800 (e.g., representing both client and server) with which aspects of the subject technology can be implemented. The computing platform(s) 802 may be configured to communicate with one or more remote platforms 804 according to a client/server architecture, a peer-to-peer architecture, and/or other architectures. The remote platform(s) 804 may be configured to communicate with other remote platforms via computing platform(s) 802 and/or according to a client/server architecture, a peer-to-peer architecture, and/or other architectures. Users may access the system 800 hosting the shared artificial reality environment and/or communication environment via remote platform(s) 804. In this way, the remote platform(s) 804 can be configured to cause sending messages, facilitate having conversations, or making other communicative actions within the shared XR environment or general communication environment on client device(s) of the remote platform(s) 804, such as via the HMD 200 and/or HMD system 250. The remote platform(s) 804 can access mixed reality content and/or mixed reality applications for use in the shared artificial reality environment for the corresponding user(s) of the remote platform(s) 804, such as via the external resources 824. The computing platform(s) 802, external resources 824, and remote platform(s) 804 may be in communication and/or mutually accessible via the network 410.

The computing platform(s) 802 may be configured by machine-readable instructions 806. The machine-readable instructions 806 may be executed by the computing platform(s) to implement one or more instruction modules. The instruction modules may include computer program modules. The instruction modules being implemented may include one or more of a reference frame module 808, tracking point identification module 810, image capture module 812, prediction module 814, rendering module 816 and/or other instruction modules.

As discussed herein, the reference frame module 808 can facilitate the generation of reference frames that define the space for rendering the mixed reality environment. The reference frame module 808 can define a coordinate system for the non-inertial reference frame. In a further aspect, the reference frame module 808 can also define a supplemental coordinate system in an inertial reference frame. In a further aspect, the prediction model can simultaneously render display images interior and exterior to the moving platform by implementing the non-inertial reference frame and inertial reference frame. The non-inertial reference frame can move relative to the moving platform. For example, the inertial reference frame can be fixed in an environment external to the moving platform (e.g., car, bus, train, boat). The reference frame module 808 can fix the non-inertial reference frame to the moving platform. In yet a further aspect, the reference frame module 808 can define a boundary region for the non-inertial reference frame. The boundary region can be defined by a threshold distance that circumscribes the non-inertial reference frame. The boundary region can be representative of the physical boundary or the moving platform. For example, the physical boundary of the moving platform may define an interior region of the car, bus, or train.

The tracking point identification module 810 can identify a plurality of tracking points for capture by the image capture device. The tracking point can comprise portions of image data that comprise unique texture such that the tracking points can be identified at subsequent instances of time. The tracking points can be identified and categorized based on their location inside the boundary region defined by the threshold distance. In a further aspect, tracking points can be identified external to the boundary region. Tracking points identified external to the boundary region can be excluded from the prediction modeling used to generate image data, such that the focus of the rendering is internal to the boundary region (inside the moving platform). In another aspect, the tracking points identified as external to the boundary region can be used to generate rendering data for locations external to the moving platform.

The prediction module 814 can use headset motion sensor data from the headset IMU, controller motion sensor data from the controller IMU, and image data associated with the plurality of tracking points captured from the headset cameras. The prediction module 814 can be configured to predict the motion of the headset and controller based on the sensor data. The prediction module 814 can then reconcile the predicted location of the headset and controller based on the image data captured from the camera. During the comparison between the predicted location determined from the respective IMU data and the actual location determined from the captured image data, the prediction module may identify discrepancies. The discrepancies can be further classified based on an error threshold. For example, if the difference between the predicted location and the actual location exceeds an error threshold, the respective tracking point can be removed from being used in rendering image data for display. The prediction module 814 can also include a tuning feature. The tuning feature can evaluate the rate of discrepancies that are determined for a certain period. In response to the discrepancies exceeding a discrepancy rate threshold, the prediction module can implement a tuning feature that alternates between a smooth or robust prediction model. The smooth module may be used for instances wherein the discrepancy rate is low, such as instances when the moving platform is experiencing a low rate of fluctuations in amplitude, velocity and acceleration. The robust module may be used for instances wherein the discrepancy rate is high, such as instances when the moving platform is experiencing a high rate of fluctuations in amplitude, velocity and acceleration (e.g., traversing a heavily damaged road).

The image capture module 812 can use the image capture devices (cameras) of the mixed reality headset to capture images of the tracking points identified by the tracking point identification module. The image capture module 812 can also define the manner in which the image capture device captures images. For example, the mixed reality device can comprise multiple cameras, and the image capture module 812 can implement variable option instructions for each camera. In one aspect, multiple cameras can capture images at the same time instance. For example, multiple cameras can capture images at 12:01.02 AM, 12:01.04 AM, 12:01.06 AM, etc. In another aspect, image capture module 812 can instruct the cameras to capture images at different instances. For example, a first camera can capture images at 12:01.02 AM, 12:01.04 AM, and 12:01.06 AM, while a second camera can capture images at 12:01.03 AM, 12:01.05 AM, and 12:01.07 AM. The additional image data at more instances of time can yield additional instances of reconciliation between the predicted location and actual location.

The rendering module 816 can take the prediction data and image data from the camera and generate display data for rendering for display in the mixed reality device.

In some implementations, the computing platform(s) 802, the remote platform(s) 804, and/or the external resources 824 may be operatively linked via one or more electronic communication links. For example, such electronic communication links may be established, at least in part, via the network 410 such as the Internet and/or other networks. It will be appreciated that this is not intended to be limiting, and that the scope of this disclosure includes implementations in which the computing platform(s) 802, the remote platform(s) 804, and/or the external resources 824 may be operatively linked via some other communication media.

A given remote platform 804 may include client computing devices, such as mixed reality device 402, mobile device 404, tablet 412, personal computer 414, laptop 416, and desktop 418, which may each include one or more processors configured to execute computer program modules. The computer program modules may be configured to enable an expert or user associated with the given remote platform 804 to interface with the system 800 and/or external resources 824, and/or provide other functionality attributed herein to remote platform(s) 804. By way of non-limiting example, a given remote platform 804 and/or a given computing platform 802 may include one or more of a server, a desktop computer, a laptop computer, a handheld computer, a tablet computing platform, a NetBook, a Smartphone, a gaming console, and/or other computing platforms. The external resources 824 may include sources of information outside of the system 800, external entities participating with the system 800, and/or other resources. For example, the external resources 824 may include externally designed XR elements and/or XR applications designed by third parties. In some implementations, some or all of the functionality attributed herein to the external resources 824 may be provided by resources included in system 800.

The computing platform(s) 802 may include the electronic storage 826, a processor such as the processors 110, and/or other components. The computing platform(s) 802 may include communication lines, or ports to enable the exchange of information with a network and/or other computing platforms. Illustration of the computing platform(s) 802 in FIG. 8 is not intended to be limiting. The computing platform(s) 802 may include a plurality of hardware, software, and/or firmware components operating together to provide the functionality attributed herein to the computing platform(s) 802. For example, the computing platform(s) 802 may be implemented by a cloud of computing platforms operating together as the computing platform(s) 802.

The electronic storage 826 may comprise non-transitory storage media that electronically stores information. The electronic storage media of the electronic storage 826 may include one or both of system storage that is provided integrally (i.e., substantially non-removable) with computing platform(s) 802 and/or removable storage that is removably connectable to computing platform(s) 802 via, for example, a port (e.g., a USB port, a firewire port, etc.) or a drive (e.g., a disk drive, etc.). The electronic storage 826 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 826 may include one or more virtual storage resources (e.g., cloud storage, a virtual private network, and/or other virtual storage resources). The electronic storage 826 may store software algorithms, information determined by the processor(s) 110, information received from computing platform(s) 802, information received from the remote platform(s) 804, and/or other information that enables the computing platform(s) 802 to function as described herein.

The processor(s) 110 may be configured to provide information processing capabilities in the computing platform(s) 802. As such, the processor(s) 110 may include one or more of a digital processor, an analog processor, a digital circuit designed to process information, an analog circuit designed to process information, a state machine, and/or other mechanisms for electronically processing information. Although the processor(s) 110 is shown in FIG. 1 as a single entity, this is for illustrative purposes only. In some implementations, the processor(s) 110 may include a plurality of processing units. These processing units may be physically located within the same device, or the processor(s) 110 may represent processing functionality of a plurality of devices operating in coordination. The processor(s) 110 may be configured to execute modules 808, 810, 812, 814, 816, and/or other modules. The processor(s) 110 may be configured to execute modules 808, 810, 812, 814, 816, and/or other modules by software; hardware; firmware; some combination of software, hardware, and/or firmware; and/or other mechanisms for configuring processing capabilities on the processor(s) 110. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although the modules 808, 810, 812, 814, and/or 816 are illustrated in FIG. 7 as being implemented within a single processing unit, in implementations in which the processor(s) 110 includes multiple processing units, one or more of the modules 808, 810, 812, 814, and/or 816 may be implemented remotely from the other modules. The description of the functionality provided by the different modules 808, 810, 812, 814, and/or 816 described herein is for illustrative purposes, and is not intended to be limiting, as any of the modules 808, 810, 812, 814, and/or 816 may provide more or less functionality than is described. For example, one or more of the modules 808, 810, 812, 814, and/or 816 may be eliminated, and some or all of its functionality may be provided by other ones of the modules 808, 810, 812, 814, and/or 816. As another example, the processor(s) 110 may be configured to execute one or more additional modules that may perform some or all of the functionality attributed below to one of the modules 808, 810, 812, 814, and/or 816.

The techniques described herein may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

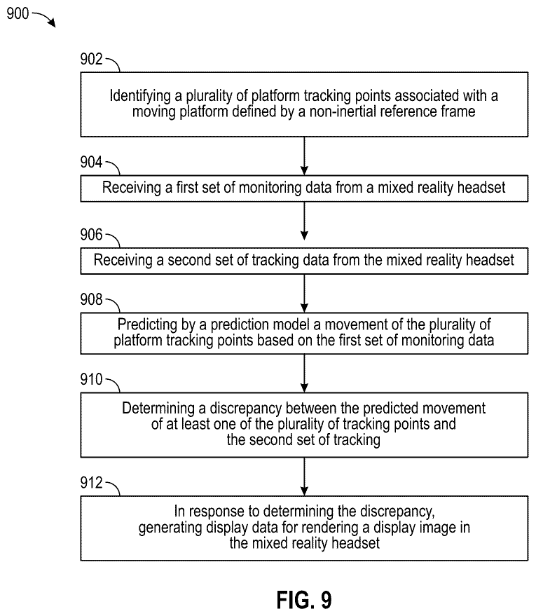

FIG. 9 illustrates an example flow diagram (e.g., process 900) for rendering media in a mixed reality headset while operating in a moving platform, according to certain aspects of the disclosure. For explanatory purposes, the example process 900 is described herein with reference to one or more of the figures above. Further for explanatory purposes, the steps of the example process 900 are described herein as occurring in serial, or linearly. However, multiple instances of the example process 900 may occur in parallel.

At step 902, the process 900 can comprise identifying a plurality of platform tracking points associated with a moving platform defined by a non-inertial reference frame. In an aspect, the boundary of the non-inertial frame can be defined as a threshold distance. For example, in the event that the moving platform is a car, the threshold distance can comprise one to three (1 to 3) meters representing the interior cavity of the automobile. In another aspect, a tracking point of the plurality of tracking points comprises a differentiable region of a captured image. In a further aspect, tracking points beyond the threshold distance may be excluded by the processor during prediction, tuning and updating since these tracking points may be oriented beyond the interior of the car. At step 904, a first set of monitoring data can be received from the mixed reality device. In an aspect, the monitoring data can comprise: at least one camera device configured to capture the plurality of tracking points, a headset inertial measurement unit (IMU), and at least one controller associated with the mixed reality headset comprising a controller inertial measurement unit (IMU).

At step 906, a second set of monitoring data can be received from the mixed reality device. In an aspect, the first set of data and the second set of data comprise similar types of data but at different instances of time. At step 908, a movement of the plurality of tracking points based on the first set can be predicted by a prediction model. At step 910, a discrepancy can be determined from comparing the predicted movement from the prediction model to the subsequent second set of monitoring data. In a further aspect, the discrepancy can be confirmed when the discrepancy exceeds a predetermined error threshold. At step 912, display data for rendering a display image in the mixed reality headset can be generated based on the discrepancy.

According to an aspect, the process 900 may further include tuning a prediction of the movement, wherein tuning comprises adjusting the prediction model. According to an aspect, the process 900 may further include removing a portion of the first set of monitoring data and the second set of monitoring data based on at least one of the discrepancies from the display data. According to an aspect, the process 900 may further include removing a portion of the plurality of tracking points from the first set and the second set based on the portion of the plurality of tracking points exceeding the threshold distance. According to an aspect, the process 900 may further include updating a prediction model, identifying signal noise parameters comprising a motion sensor associated with the IMU of the headset device, a controller motion sensor associated with the IMU of the controller and an image capture device, and implementing the signal noise parameters to the prediction model. According to an aspect, the process 900 may further include, via the mixed reality headset, correlating the first set of monitoring data and the second set of monitoring data associated with the inertial reference frame with the first set of monitoring data and the second set of monitoring data associated with the non-inertial reference frame.

Process 900 may also include steps to allow rendering of images external to the moving platform. For example, the process can include identifying supplemental tracking points oriented external to the moving platform; augmenting the first set of monitoring data to include the supplemental tracking points; and augmenting the second set of monitoring data to include the supplemental tracking points. With the additional data from the augmented set of monitoring data, the process can include updating the prediction model and the discrepancy to include the platform tracking points and supplemental tracking points. In a further aspect, the supplemental tracking points can be identified based on correlating the supplemental tracking points to an inertial reference frame.

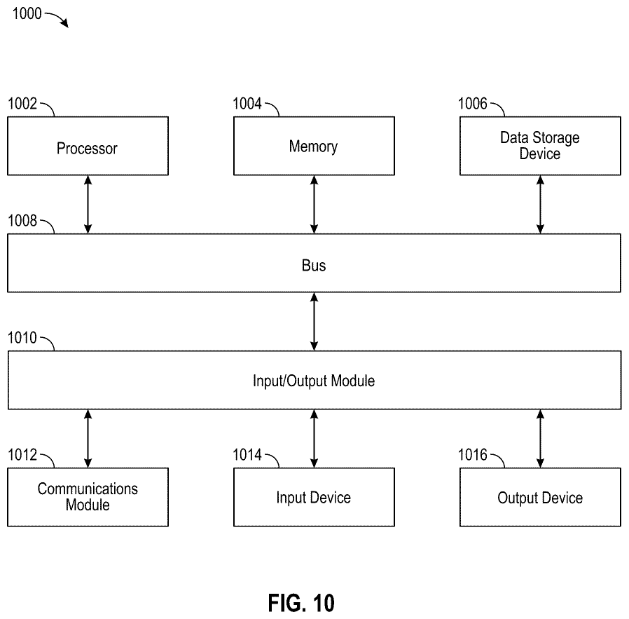

FIG. 10 is a block diagram illustrating an exemplary computer system 1000 with which aspects of the subject technology can be implemented. In certain aspects, the computer system 1000 may be implemented using hardware or a combination of software and hardware, either in a dedicated server, integrated into another entity, or distributed across multiple entities.

The computer system 1000 (e.g., server and/or client) includes a bus 1008 or other communication mechanism for communicating information, and a processor 1002 coupled with the bus 1008 for processing information. By way of example, the computer system 1000 may be implemented with one or more processors 1002. Each of the one or more processors 1002 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

The computer system 1000 can include, in addition to hardware, code that creates an execution environment for the computer program in question, e.g., code that constitutes processor firmware, a protocol stack, a database management system, an operating system, or a combination of one or more of them stored in an included memory 1004, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1008 for storing information and instructions to be executed by processor 1002. The processor 1002 and the memory 1004 can be supplemented by, or incorporated in, special purpose logic circuitry.

The instructions may be stored in the memory 1004 and implemented in one or more computer program products, i.e., one or more modules of computer program instructions encoded on a computer-readable medium for execution by, or to control the operation of, the computer system 1000, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1004 may also be used for storing temporary variable or other intermediate information during execution of instructions to be executed by the processor 1002.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

The computer system 1000 further includes a data storage device 1006 such as a magnetic disk or optical disk, coupled to bus 1008 for storing information and instructions. The computer system 1000 may be coupled via input/output module 1010 to various devices. The input/output module 1010 can be any input/output module. Exemplary input/output modules 1010 include data ports such as USB ports. The input/output module 1010 is configured to connect to a communications module 1012. Exemplary communications modules 1012 include networking interface cards, such as Ethernet cards and modems. In certain aspects, the input/output module 1010 is configured to connect to a plurality of devices, such as an input device 1014 and/or an output device 1016. Exemplary input devices 1014 include a keyboard and a pointing device, e.g., a mouse or a trackball, by which a user can provide input to the computer system 1000. Other kinds of input devices can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1016 include display devices such as an LCD (liquid crystal display) monitor, for displaying information to the user.

According to one aspect of the present disclosure, the above-described systems can be implemented using a computer system 1000 in response to the processor 1002 executing one or more sequences of one or more instructions contained in the memory 1004. Such instructions may be read into memory 1004 from another machine-readable medium, such as data storage device 1006. Execution of the sequences of instructions contained in the main memory 1004 causes the processor 1002 to perform the process steps described herein. One or more processors in a multi-processing arrangement may also be employed to execute the sequences of instructions contained in the memory 1004. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

The computer system 1000 can include clients and servers. A client and server are generally remote from each other and typically interact through a communication network. The relationship of client and server arises by virtue of computer programs running on the respective computers and having a client-server relationship to each other. The computer system 1000 can be, for example, and without limitation, a desktop computer, laptop computer, or tablet computer. The computer system 1000 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to the processor 1002 for execution. Such a medium may take many forms, including, but not limited to, non-volatile media, volatile media, and transmission media. Non-volatile media include, for example, optical or magnetic disks, such as the data storage device 1006. Volatile media include dynamic memory, such as the memory 1004. Transmission media include coaxial cables, copper wire, and fiber optics, including the wires that comprise the bus 1008. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 1000 reads XR data and provides an artificial reality, information may be read from the XR data and stored in a memory device, such as the memory 1004. Additionally, data from the memory 1004 servers accessed via a network, the bus 1008, or the data storage 1006 may be read and loaded into the memory 1004. Although data is described as being found in the memory 1004, it will be understood that data does not have to be stored in the memory 1004 and may be stored in other memory accessible to the processor 1002 or distributed among several media, such as the data storage 1006.

The techniques described herein may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A method for rendering media in a mixed reality headset while operating in a moving platform, the method comprising:
identifying a plurality of platform tracking points associated with a moving platform defined by a non-inertial reference frame;
receiving a first set of monitoring data from a mixed reality headset comprising:
at least one camera device configured to capture the plurality of platform tracking points, and
a headset inertial measurement unit (IMU);
receiving a second set of monitoring data from the mixed reality headset;
predicting by a prediction model a movement of the plurality of platform tracking points based on the first set of monitoring data;
determining a discrepancy between the predicted movement of at least one of the plurality of platform tracking points and the second set of monitoring data, wherein the discrepancy exceeds an error threshold; and
in response to determining the discrepancy, generating display data for rendering a display image in the mixed reality headset.

2. The method of claim 1, wherein receiving the first set of monitoring data further comprises at least one controller associated with the mixed reality headset comprising a controller inertial measurement unit (IMU); and receiving the second set of monitoring data further comprises the at least one controller associated with the mixed reality headset comprising the controller inertial measurement unit (IMU).

3. The method of claim 2, further comprising:
updating a prediction model;
identifying signal noise parameters from motion of the moving platform; and
implementing the signal noise parameters to the prediction model.

4. The method of claim 1, wherein predicting the movement of the plurality of platform tracking points further comprises tuning a prediction of the movement, wherein tuning comprises adjusting the prediction model.

5. The method of claim 1, further comprising removing a portion of the first set of monitoring data and the second set of monitoring data based on at least one of the discrepancies from the display data.

6. The method of claim 1, further comprising removing a portion of the plurality of platform tracking points from the first set and the second set based on the portion of the plurality of platform tracking points exceeding a threshold distance, wherein the threshold distance is determined by the moving platform.

7. The method of claim 1, wherein the tracking point of the plurality of platform tracking points comprises a differentiable region of a captured image.

8. The method of claim 1, further comprising:
identifying supplemental tracking points oriented external to the moving platform;
augmenting the first set of monitoring data to include the supplemental tracking points;
augmenting the second set of monitoring data to include the supplemental tracking points; and
updating the prediction model and the discrepancy to include the platform tracking points and supplemental tracking points.

9. The method of claim 8, wherein identifying the supplemental tracking points is based on correlating the supplemental tracking points to an inertial reference frame.

10. A system for rendering media for a mixed reality headset while operating in a moving platform, comprising:
one or more processors;
a memory comprising instructions stored thereon, which when executed by the one or more processors, causes the one or more processors to perform:
identifying a plurality of platform tracking points associated with a moving platform defined by a non-inertial reference frame;
receiving a first set of monitoring data from a mixed reality headset comprising:
at least one camera device configured to capture the plurality of platform tracking points, and
a headset inertial measurement unit (IMU);
receiving a second set of monitoring data from the mixed reality headset;
predicting by a prediction model a movement of the plurality of platform tracking points based on the first set of monitoring data;
determining a discrepancy between the predicted movement of at least one of the plurality of platform tracking points and the second set of monitoring data, wherein the discrepancy exceeds an error threshold; and
in response to determining the discrepancy, generating display data for rendering a display image in the mixed reality headset.

11. The system of claim 10, wherein receiving the first set of monitoring data further comprises at least one controller associated with the mixed reality headset comprising a controller inertial measurement unit (IMU); and receiving a second set of monitoring data further comprises the at least one controller associated with the mixed reality headset comprising a controller inertial measurement unit (IMU).

12. The system of claim 10, wherein predicting the movement of the plurality of platform tracking points further comprises tuning a prediction of the movement, wherein tuning comprises adjusting the prediction model.

13. The system of claim 10, wherein the instructions further comprise:
updating a prediction model;
identifying signal noise parameters from motion of the moving platform; and
implementing the signal noise parameters to the prediction model.

14. The system of claim 10, wherein the instructions further comprise:
identifying supplemental tracking points oriented external to the moving platform;
augmenting the first set of monitoring data to include the supplemental tracking points;
augmenting the second set of monitoring data to include the supplemental tracking points; and
updating the prediction model and the discrepancy to include the platform tracking points and supplemental tracking points.

15. The system of claim 14, wherein identifying the supplemental tracking points is based on correlating the supplemental tracking points to an inertial reference frame.

16. A non-transitory computer-readable storage medium comprising instructions stored thereon, which when executed by one or more processors, cause the one or more processors to perform operations for a mixed reality headset monitoring a moving platform, comprising:
identifying a plurality of platform tracking points associated with a moving platform defined by a non-inertial reference frame;
receiving a first set of monitoring data from a mixed reality headset comprising:
at least one camera device configured to capture the plurality of platform tracking points, and
a headset inertial measurement unit (IMU);
receiving a second set of monitoring data from the mixed reality headset;
predicting by a prediction model a movement of the plurality of platform tracking points based on the first set of monitoring data;
determining a discrepancy between the predicted movement of at least one of the plurality of platform tracking points and the second set of monitoring data, wherein the discrepancy exceeds an error threshold; and
in response to determining the discrepancy, generating display data for rendering a display image in the mixed reality headset.

17. A non-transitory computer-readable storage medium of claim 16, wherein receiving the first set of monitoring data further comprises at least one controller associated with the mixed reality headset comprising a controller inertial measurement unit (IMU); and receiving a second set of monitoring data further comprises the at least one controller associated with the mixed reality headset comprising a controller inertial measurement unit (IMU).

18. A non-transitory computer-readable storage medium of claim 16, further comprising:
updating a prediction model;
identifying signal noise parameters from motion of the moving platform; and
implementing the signal noise parameters to the prediction model.

19. A non-transitory computer-readable storage medium of claim 16, wherein the first set of monitoring data is differentiated from the second set of monitoring data by different time instances.

20. A non-transitory computer-readable storage medium of claim 16, further comprising:
identifying supplemental tracking points oriented external to the moving platform;
augmenting the first set of monitoring data to include the supplemental tracking points;
augmenting the second set of monitoring data to include the supplemental tracking points; and
updating the prediction model and the discrepancy to include the platform tracking points and supplemental tracking points.
